(19) United States
(12) Patent Application Publication
(10) Pub. No.: US 2015/0191943 A1
(43) Pub. Date: Jul. 9, 2015

(54) WIRELESSLY CONTROLLED VEHICLE HOOD LOCK

(71) Applicant: Craig A. Tieman, Westfield, IN (US)

(72) Inventor: Craig A. Tieman, Westfield, IN (US)

(21) Appl. No.: 14/587,326

(22) Filed: Dec. 31, 2014

Related U.S. Application Data
(60) Provisional application No. 61/923,653, filed on Jan. 4, 2014.

(51) Int. Cl. E05B 83/24; E05B 81/00

(52) U.S. Cl. CPC E05B 83/24; E05B 81/00

(57) ABSTRACT

A wireless lock module is disclosed that is operable to control the ability to open a hood of a vehicle. The wireless lock module includes a transceiver that receives wireless control commands from a control device, such as a smartphone. Upon receiving the control commands, the transceiver communicate with a controller contained within the wireless lock module. The controller, in turn, controls the operation of an actuator to selectively move a locking device into position to either permit opening of the vehicle hood or restrict opening of the vehicle hood. The locking device can include a jam block that is positioned to selectively allow a hood latch to rotate between an engaged position and a release position. The wireless lock module can include an internal power supply such that the entire wireless lock module is a self-contained device that can be positioned within the engine compartment of the vehicle.

### CROSS-REFERENCE TO RELATED APPLICATION

The present application is based on and claims priority to U.S. Provisional Patent application Ser. No. 61/923,653 filed Jan. 4, 2014, the disclosure of which is incorporated herein by reference.

### BACKGROUND

The present disclosure relates to vehicle locking systems, specifically to a wirelessly controlled lock module of a singular design which can be added to existing vehicle engine hood latches without special tools or training to permit external control through a wireless link to a mobile control device. Electrical and electronic systems in automotive vehicles provide numerous functions related to the normal starting and driving operation, convenience, entertainment, access and security for vehicles.

Every year, vehicle manufacturers introduce vehicles with increasing numbers of features which enhance convenience, entertainment, access and security. In addition, thieves continually attempt to learn how to circumvent vehicle security systems in an attempt to steal vehicles or vehicle components, which makes all vehicles vulnerable to theft despite the sophistication of their original electronic equipment. Furthermore, hood latching systems in vehicles have become highly standardized in their design and all have a handle inside the vehicle near the driver which pulls a cable to remotely release the mechanical latch which locks the hood closed. If a thief can gain access to the inside of a vehicle, they can easily open the engine hood to gain access to components which aid in the vehicle theft.

In recent years, the rapid and widespread growth in long-range wireless connectivity and sophisticated hand-held mobile devices with touch-type graphical user interfaces and short or long range wireless connectivity has led to the proliferation of machine-to-machine connectivity solutions and “anywhere at any time” device interactivity. Consumers now expect allot then vehicles, homes and devices to be connected and able to be interacted with via their mobile technology from anywhere and at any time. They also expect enhanced security of their vehicles to be included with new technology.

Vehicle manufacturers design all vehicles to include a standard, mechanical hood latch with a remote control pull cable routed inside the vehicle in a location convenient to the driver. No provision to provide additional under-hood security is provided in the event a thief gains access to the inside of a vehicle.

For many years, aftermarket vehicle electronics suppliers hake been offering retrofittable security and convenience systems to expand the capabilities available to vehicle owners. Security system enhancements are available to enhance the existing vehicle security features through addition of custom mechanical locking mechanisms or connections to existing vehicle electronic systems to override normal operation and create greater barriers to thieves who must overcome these systems to steal a vehicle. Other aftermarket system enhancements include the addition of remote vehicle start and keyless entry. Currently available mechanical add-on hood lock enhancements typically require drilling or cutting on a vehicle and require special tools and training to install. Electronic security systems will integrate via wires with the original vehicle electrical system and can be defeated by a thief if they can gain access to them under the hood of the vehicle.

Presently, no wirelessly controlled locking device of a singular design which can be added to all existing vehicle engine hood latches without special tools or training to permit external control through linkage to mobile devices, currently exists

### SUMMARY

The present disclosure relates to a universal, retrofittable add-on wirelessly controlled vehicle hood locking device which can be operated by a separate control device. The system includes an RF transceiver, controller and power supply controlling a servo-type lock motor which moves a jam block to interfere with hood latch assembly latch release, thus preventing vehicle hood opening.

In one embodiment of the disclosure, the lock motor is connected to a flexible, rotatable shaft within a lock motor cable at one end and the other end of the cable is connected to a jam block. The jam block is designed with a simple clamping arrangement intended to fit tightly or clamp around most safety hooks in vehicles with no or simple tools (e.g. snap-action lock or screwdriver). The flexible, rotatable driveshaft passes through the cable to transfer motor rotation through the cable and jam block mount to where a jam block is mounted to the opposite end of the shaft. Operation of the motor will rotate the jam block over a 90 degree angle. With the jam block rotated up and out of the way, hood lock function is unaffected. With the jam block rotated down while the vehicle hood is down and locked, the jam block will prevent the vehicle hood latch from opening and releasing the striker. The jam block mount is designed to be easily fitted to any existing hood latch assembly's safety hook with a bolt-on or clamp-on arrangement. The lock motor cable has sufficient length and flexibility to permit locating the lock, motor and the RF transceiver and controller and power supply in convenient underhood locations out of reach of potential thieves.

The system can be either a self-contained mobile device with a short-range RF transceiver or a vehicle mounted gateway telematics device which extends the range of the wirelessly controlled vehicle hood lock to reach a remotely-located mobile device. The short-range RF transceivers could use Bluetooth®, NFC or any other suitable RF modulation and protocol to accomplish wireless transmission of lock commands.

Accordingly, this wireless hood lock module could be installed by nearly anyone with simple instructions as an add-on secondary hood lock to their vehicle which will permit the vehicle owner to remotely lock or unlock the secondary hood lock. Remote control can be extended to the user's mobile devices over wireless links to provide short to long-range control when used in conjunction with appropriate in-vehicle telematics systems.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a schematic illustration of the components of the wireless lock module;

FIG. 2 is a rear isometric view of the lock module and hood latch assembly;

FIG. 3 is a view similar to FIG. 2 further showing the jam block in the engaged position;

FIG. 4 is a front isometric view of the jam block and hood latch assembly;

FIG. 5 is a view similar to FIG. 4 with the jam block in its released position;

FIG. 6 is a rear isometric view similar to FIG. 2 with the jam block in its released position;

FIG. 7 is a front isometric view of a second, alternate embodiment of blocking device in a locking position; and

FIG. 8 is a front isometric view of the second embodiment of the blocking device in the release position.

### DETAILED DESCRIPTION

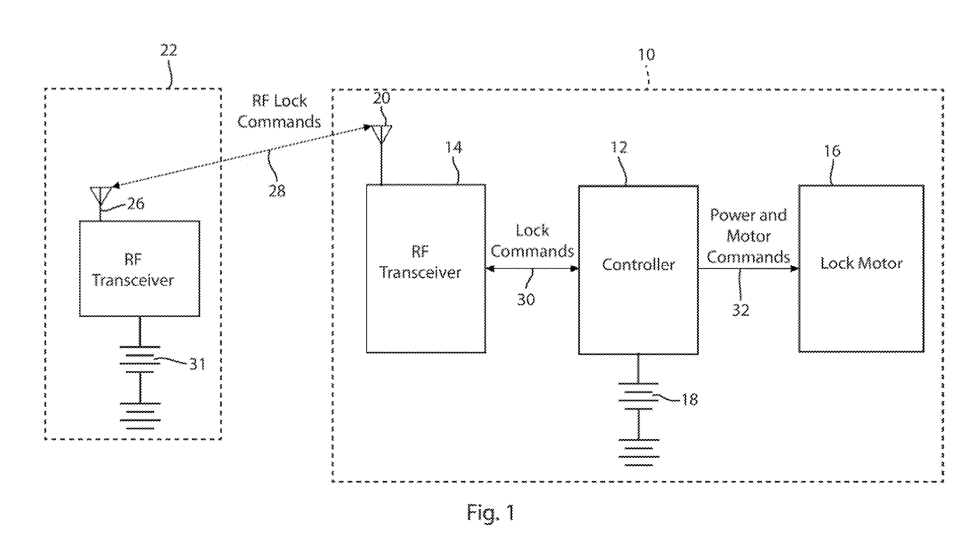

FIG. 1 is a schematic diagram of a self-powered, wireless lock module 10 constructed in accordance with the present disclosure. The wireless lock module 10 includes a controller 12 that interfaces with both an RF transceiver 14 and an actuator, such as a lock motor 16. Although the actuator is shown in the Figures as being a motor 16, other types of actuators, such as a solenoid, piston or the like, are contemplated as being within the scope of the present disclosure. The controller 12, RF transceiver 14 and lock motor 16 all receive power from an internal power supply contained within the lock module 10. In the embodiment shown in FIG. 1, a battery 18 is included within the lock module 10 to provide the required power for the internal components of the lock module. In this manner, the entire lock module 10 can be a self-powered, self-contained unit that can be installed within the engine compartment of a vehicle.

The RF transceiver 14 includes an antenna 20 that can receive wireless control signals from an external control device 22. In the embodiment illustrated, the external control device 22 may be a wireless mobile device, such as a smartphone, that includes an internal RF transceiver 24 that is able to transmit wireless control signals through an antenna 26. The wireless control signals are shown by the wireless transmission signal arrow 28 in FIG. 1. The control device 22 includes a graphical user interface and an internal battery 31 that provides the operating power necessary to transmit wireless control signals from the control device 22 to the wireless lock module 10. Although the control device 22 is shown as being a separate user operable device, in an alternate embodiment, the control device 22 may be a gateway device with an RF transceiver located within the vehicle that communicates wirelessly to the RF transceiver 14 contained within the lock module 10.

When the RF transceiver 14 contained within the lock module 10 receives a control signal from the control device 22, the RF transceiver 14 communicates to the controller 12 through a communication line 30. When the controller 12 receives a control signal along line 30, the controller 12 can control the operation of the actuator through a control line 32. As will be described in greater detail below, the actuator in the illustrated embodiment is a lock motor 16 that controls the operative position of a jam block that controls the ability of a user to open the hood of a motor vehicle. Since the lock module 10 is a self-contained unit that can be positioned within the engine compartment of a vehicle, a user can control the access to the engine compartment through use of the external control device 22 and the wireless command signals transmitted from the external control device 22 to the lock module 10.

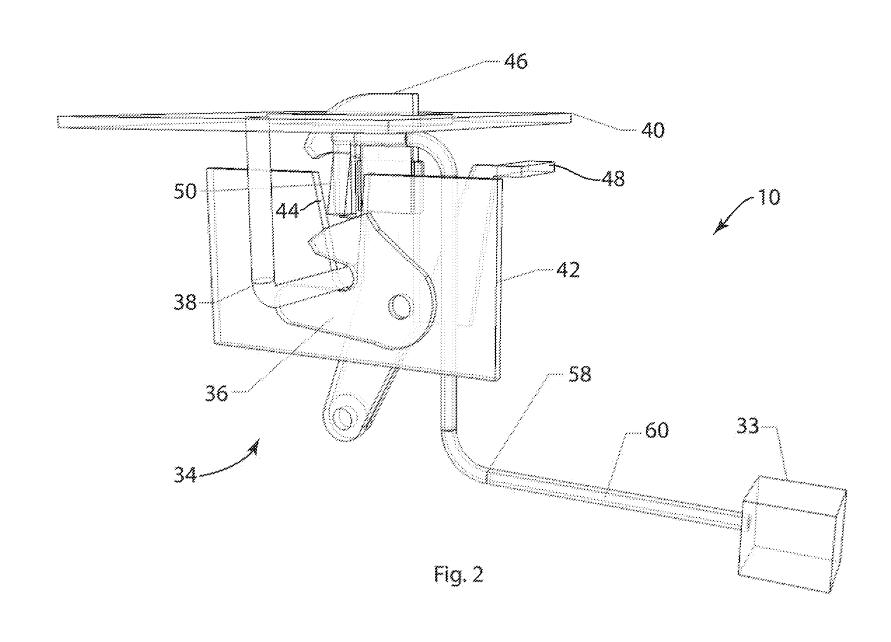

FIG. 2 illustrates one embodiment of the wireless lock module 10 constructed in accordance with one embodiment of the present disclosure. In the embodiment shown in FIG. 2, a hood latch assembly 34 of the vehicle is generally illustrated. The hood latch assembly 34 includes a hood latch 36 that engages a striker 38 that is mounted to a lower surface of a striker mount plate 40. The striker mount plate 40, in turn, is secured to an inner surface of the hood of the vehicle. As illustrated in FIG. 2, the hood latch 36 engages the striker 38 to hold the hood in a closed position. The hood latch 36 is mounted to a base 42 that includes a V-shaped notch 44 that allows the striker 38 to move vertically relative to the hood latch 36. In the embodiment illustrated, the striker 38 is a U-shaped rod that provides a point of engagement for the hood latch 36.

The hood latch assembly 34 further includes a safety hook 46 that receives the striker 38 when the striker is released by the hood latch 36. The safety hook 46 is manually released by an operator through a release lever 48. As is well known, the safety hook 46 prevents the hood from opening during operation of the motor vehicle upon inadvertent release of the hood latch 36.

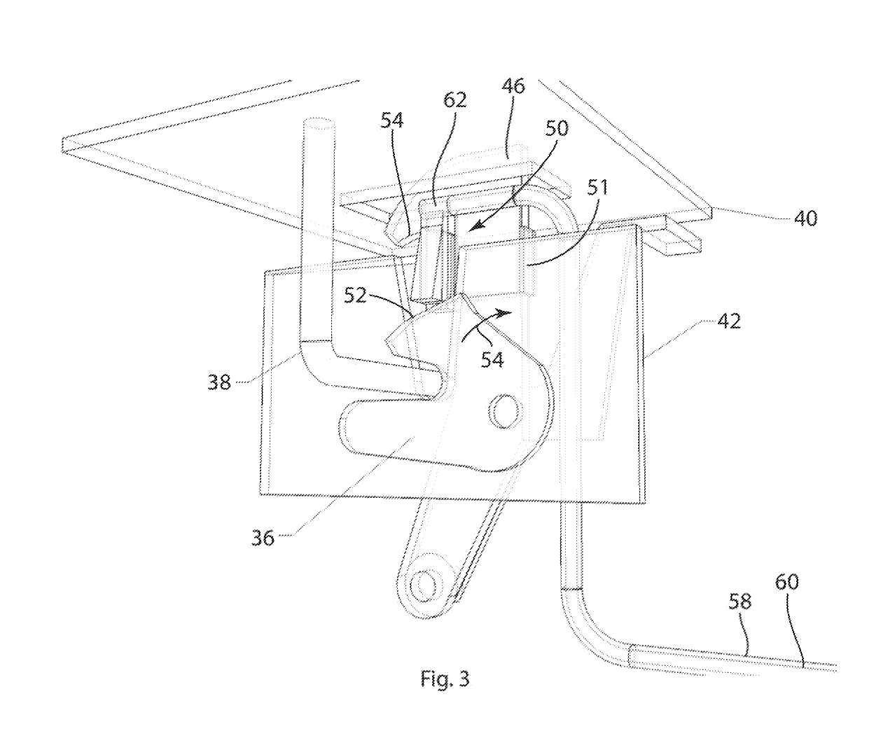

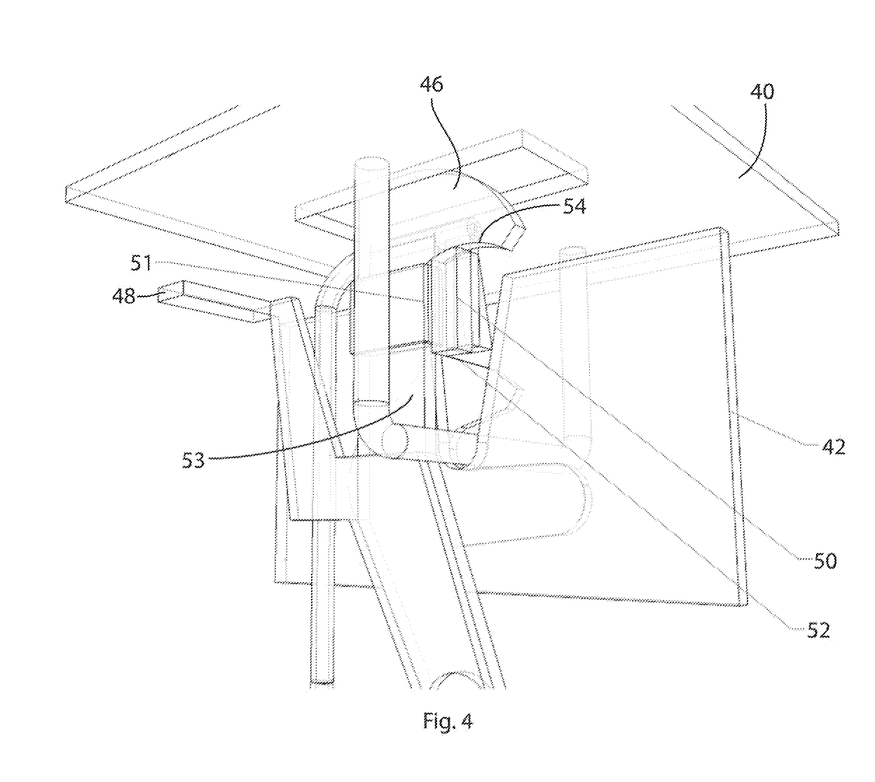

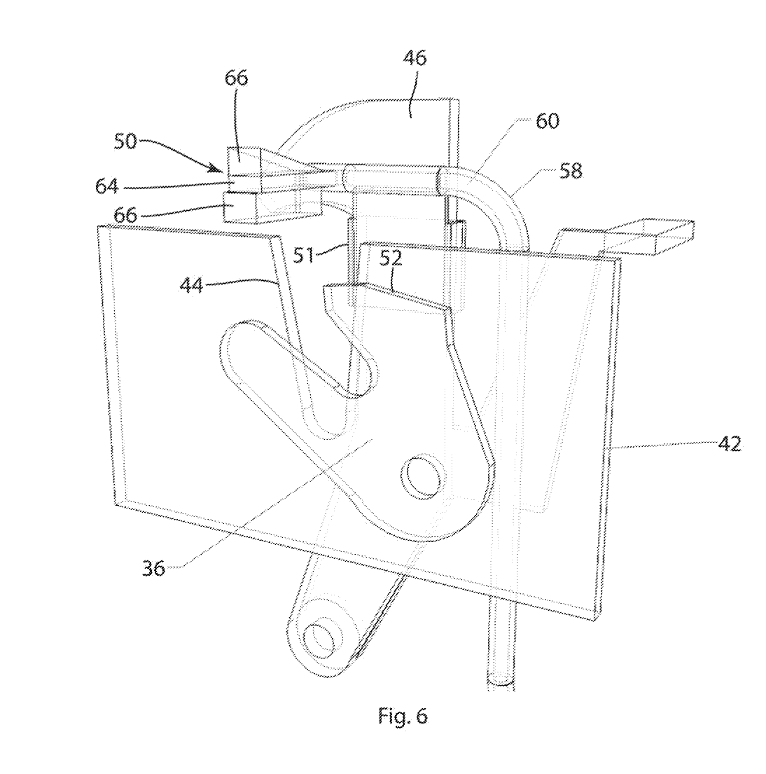

Referring now to FIG. 3, the wireless lock module of the present disclosure includes a jam block 50 that can prevent rotation of the hood latch 36 from the locked position shown in FIG. 3 to the rotated, release position shown in FIG. 6. As illustrated in FIG. 4, the jam block 50 is supported on a mounting bracket 51 that is secured to as lower portion 53 of the safety hook 46. The jam block 50 is physically positioned to contact a top surface 52 of the hood latch 36. When the jam block 50 is in the engagement position shown in FIG. 3, the jam block physically prevents the hood latch 36 from rotating in the direction shown by arrow 56. Thus, when the jam block 50 is in its blocking position shown in FIG. 3, the hood latch 36 cannot rotate to a release position to release the striker 38.

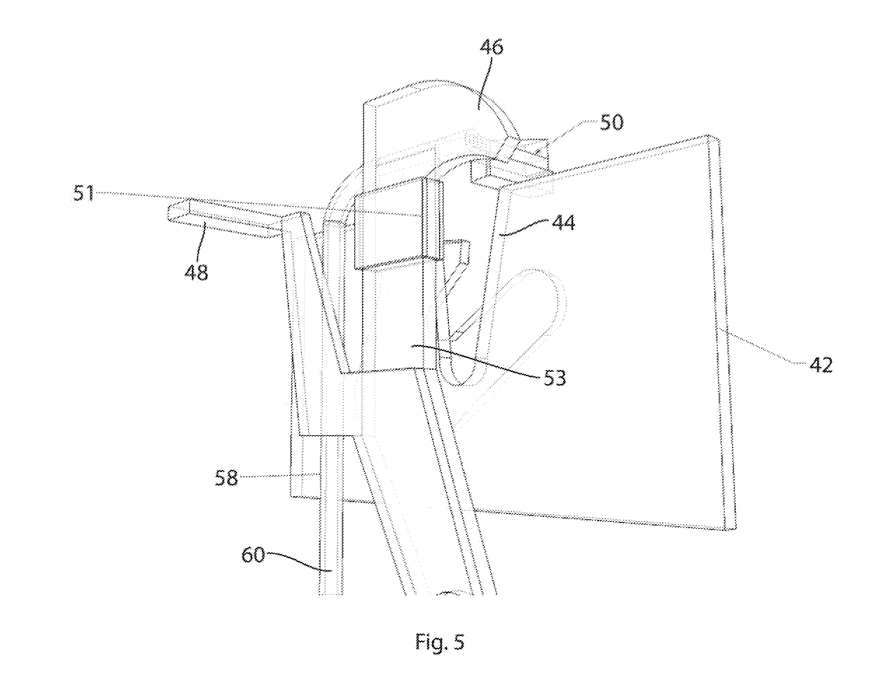

As illustrated in FIGS. 2 and 3, the jam block 50 is connected to a lock motor cable 58 that includes an internal drive shaft 60. The drive shaft 60 is connected to the actuator contained within the outer housing 33, as shown in FIG. 2. When the lock motor operates, the lock motor rotates the drive shaft 60. As illustrated in FIG. 3, an outer end 62 of the drive shaft 60 is directly connected to the jam block 50. Rotation of the drive shaft 60 causes the jam block 50 to rotate about the mounting bracket 51 into a release position, as best illustrated in FIG. 5. When the jam block 50 is in its release position, the hood latch 36 can rotate to release the striker 38. Thus, operation of the lock motor to rotate the drive shaft moves the jam block 50 from the engagement position shown in FIG. 3 to the release position shown in FIG. 5. In this manner, the operation of the lock motor can control whether or not the hood latch 36 can release the striker to allow opening of the vehicle hood.

As illustrated in FIG. 6, the jam block 50 includes a mounting portion 64 that is connected to the drive shaft 60. The mounting portion 64 includes one or more blocks 66 that provide the physical portion of the jam block 50 that engages the to surface 52 of the hood latch 36. Although a specific configuration of the jam block 50 is illustrated, it should be understood that the jam block could take many different forms as long as the jam block prevents physical rotation of the hood latch 52 to release the striker 38.

In operation, the hood latch assembly 34 shown in the drawing figures secures the vehicle hood in the locked position through use of the hood latch 36. The hood latch 36 is locked in the engagement position by the use of a pawl (not shown). The hood latch 36 is released from its locked position shown in FIG. 2 by typically pulling upon a release cable (not shown). When the release cable is actuated, a spring urges the striker 38 in an upward direction, causing the hood latch 36 to rotate from the locked position in FIG. 2 to the unlocked position shown in FIG. 6. The vehicle hood will move upward until the striker is stopped by the safety hook 46. As discussed, the safety hook 46 prevents inadvertent hood opening while the vehicle is in motion.

Once the striker is released from the hood latch 36, the user accesses a lever 48 to release the striker from the safety hook 46, which allows the uninhibited opening of the vehicle hood.

Installation of the wireless lock module within the engine compartment of the vehicle will limit the ability of unauthorized access to the engine compartment of a vehicle. As previously described, the jam block 50, when in the blocking position, will prevent release of the hood latch 36.

Installation of the wireless lock module 10 will initially require the user to open the vehicle hood and the hood latch 36 will be rotated to the locked position. Once the hood latch 36 is in the locked position, the jam block mounting bracket 51 will be attached to the safety hook 46 and will be positioned such that the block 50 engages the top surface 52 as shown in FIG. 3. Once the jam block is positioned, the jam block will be released and the vehicle hood can be closed.

During operation, if the user wishes to access the internal engine compartment, the user will utilize the external control device 22 to send a wireless RF signal, as illustrated by arrow 28 in FIG. 1. The wireless RF signal will be received by the RF transceiver 14 contained within the lock module 10. The RF transceiver 14 will relay this signal to the controller 12 which in turn sends a command signal to the lock motor 16. As described previously, the lock motor 16 will rotate the drive shaft 60, causing the jam block to rotate into the release position shown in FIG. 6. When in the release position, the user will be able to release the hood latch 36 and access the engine compartment as normal.

Conversely, if the user wishes to prevent opening of the hood, the user can send a lock signal from the external control device 22 to the RF transceiver 14 of the wireless lock module 10. When the wireless lock module 10 receives the locking signal, the controller 12 will generate the required signal to cause the lock motor to rotate the jam block downward until it fills the gap between the hood latch 36 and the safety hook 46. In this manner, the user can control the ability to access the engine compartment through the wireless lock module 10.

Although the embodiment shown in FIG. 1 includes to separate lock module 10 powered by the internal battery 18, the lock module 10 could be powered by the vehicle battery instead of the internal battery 18. Additionally, the jam block could be rotated by a push or pull cable driven by either a servomotor or a solenoid in link arms. The lock motor 16 could also be designed as having an additional safety release cord added as a fail-safe backup in case of the loss of power or failure of the lock motor.

In the embodiment illustrated, the jam block prevents rotation of the hood latch. However, the jam block could be located at other positions and engage other portions of the hood latch assembly to prevent opening of the hood and release of the striker.

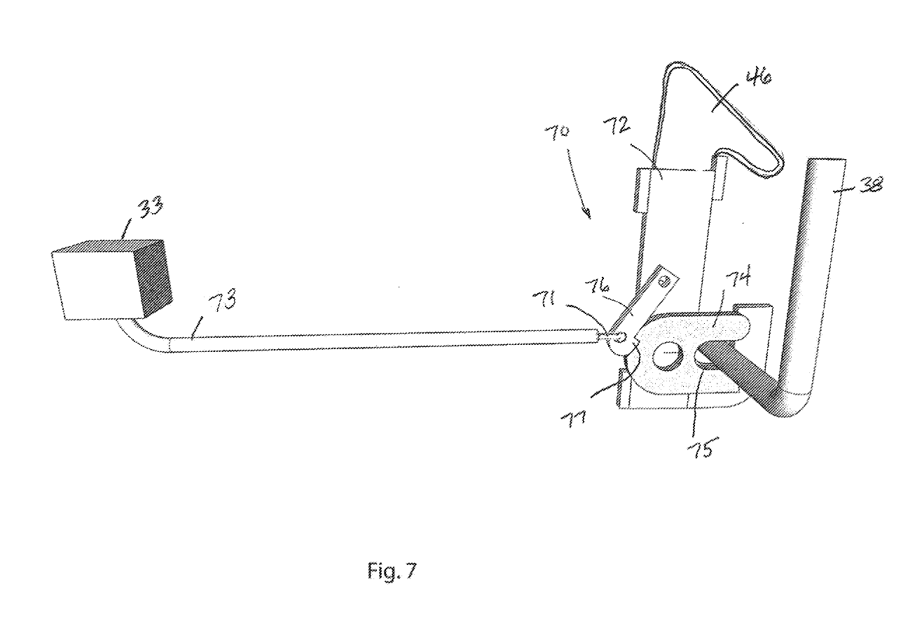

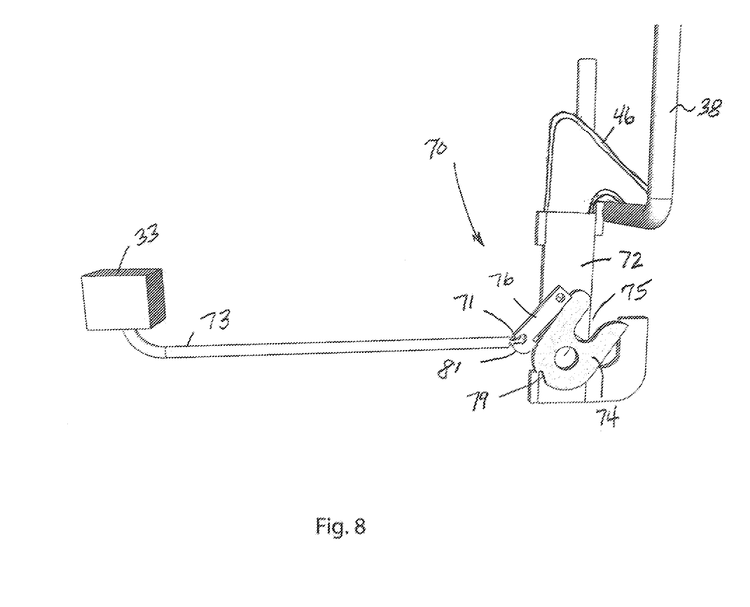

FIG. 7 illustrates a second, alternate embodiment of a wireless lock module 70. The wireless lock module 70 includes a similar control housing 33 that includes the RF transceiver and controller similar to the embodiment of FIG. 1. The controller drives a lock motor or a solenoid that pulls on a cable 71 within an outer cable sleeve 73. The wireless lock module in the embodiment shown includes a mounting block 72 that clamps onto the body of the safety hook 46. The mounting block 72 includes both a secondary hood latch 74 and a pawl 76. The secondary hood latch 74 includes an open receiving slot 75 that receives the striker 38 in the locking position shown in FIG. 7. Although not shown, a bias spring urges the secondary hood latch 74 into the release position shown in FIG. 8. The pawl 76 is spring biased into the locking position shown in FIG. 7 such that a tooth 77 on the pawl 76 is received in a notch 79 (FIG. 8) on the secondary hood latch 74 to hold the secondary hood latch 74 in the locking position of FIG. 7.

The internal cable 71 is securely connected to an attachment point on the outer end 81 of the pawl 76. When the internal cable 71 is retracted by the lock motor or solenoid, the pawl 76 rotates against the spring bias force and the tooth 77 moves out of engagement with the notch 79 formed on the secondary hood latch 74, as shown in FIG. 8.

When the user wishes to release the hood, the user sends the wireless command signal as was the case in the first embodiment. When the command signal is received, the lock motor or solenoid retracts the cable 71, which causes the pawl 76 to rotate to the release position of FIG. 8. In this position, the secondary hood latch 74 moves to the release position of FIG. 8, which allows the striker 38 to move up into contact with the safety hook 46. The user must then release the safety hook 46 as is conventional. Thus, in the second embodiment shown in FIGS. 7 and 8, the wireless lock module 70 responds to a wireless command signal to allow the hood to be opened while preventing such opening in the default position.

As described in the above description, the wireless, remote controlled vehicle lock module is an add-on device that provides an additional layer of vehicle security to prevent theft of the vehicle or other engine components. The lock module of the present disclosure does not require any professional installation. Further, no vehicle modifications would be necessary to mount the lock module in the position as shown.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A system for controlling the ability to release a hood of a vehicle having a hood latch, the system comprising:
a control device having a transceiver for transmitting control commands;
a wireless lock module including a control module transceiver that communicates with the transceiver of the control device to receive control commands;
an actuator contained within the lock module and operable based upon the received control commands; and
a locking device movable by the actuator between an engaged position to prevent release of the hood latch and a release position that permits release of the hood latch.

2. The system of claim 1, wherein the actuator motor contained within the wireless lock module.

3. The system of claim 2 wherein the locking device is a jam block positioned to selectively prevent movement of the hood latch when the jam block is in the engaged position.

4. The system of claim 3 wherein the jam block is mounted to a drive shaft connected to the drive motor, wherein the drive motor operates to rotate the jam block through the drive shaft.

5. The system of claim 1 wherein the lock module includes an internal power supply.

6. The system of claim 1 wherein the control device is a smartphone.

7. The system of claim 1 wherein the wireless lock module is mounted within an engine compartment of the vehicle.

8. A system for controlling the release of a hood of a vehicle having a hood latch rotatable between a locking position and a release position, the system comprising:
a control device having a transceiver for transmitting control commands;
a wireless lock module including a control module transceiver that communicates with the transceiver of the control device to receive control commands;
an actuator contained within the lock module and operable based upon the received control commands; and
a locking device movable by the actuator between an engaged position to prevent rotation of the hood latch to the release position and a release position to permit rotation of the hood latch to the release position.

9. The system of claim 8 wherein the locking device is a jam block, positioned to contact the hood latch in the engaged position.

10. The system of claim 9 wherein the jam block is connected to a drive shaft operable to rotate the jam block between the engaged and release positions.

11. The system of claim 8 wherein the actuator is a drive motor contained within the wireless lock module.

12. The system of claim 8 wherein the lock module includes an internal power supply.

13. A wireless lock module for controlling the release of a hood of a vehicle having a hood latch rotatable between a locking position and a release position, the wireless lock module comprising:
an outer housing;
a control module transceiver contained within the outer housing that receives wireless control commands;
an actuator contained within the outer housing and operable based upon the received control commands; and
a locking device movable by the actuator between an engaged position to prevent rotation of the hood latch to the release position and a release position to permit rotation of the hood latch to the release position.

14. The wireless lock module of claim 13 wherein the locking device is a jam block positioned to contact the hood latch in the engaged position.

15. The wireless lock module of claim 13 wherein the actuator is a drive motor contained within the outer housing and coupled to the locking device by a drive shaft.

16. The wireless lock, module of claim of claim 15 wherein the jam block is connected to the drive shaft.

17. The wireless lock module of claim 13 further comprising an internal power supply positioned to provide power to the control module transceiver and the actuator.

18. The wireless lock module of claim 13 further comprising a controller contained within the outer housing, wherein the controller receives the control commands from the transceiver and controls operation of the locking device.
